(19) United States
(12) Patent Application Publication
(10) Pub. No.: US 2014/0168781 A1
(43) Pub. Date: Jun. 19, 2014

(54) LIGHT CONVERGING DEVICE AND REPAIRING MACHINE

(71) Applicant: SHENZHEN CHINA STAR OPTOELECTRONICS TECHNOLOGY CO., LTD., Shenzhen, Guangdong (CN)

(72) Inventors: Wen-da Cheng, Shenzhen (CN); Chujen Wu, Shenzhen (CN)

(73) Assignee: SHENZHEN CHINA OPTOELECTRONICS TECHNOLOGY CO., LTD., Shenzhen,Guangdong (CN)

(21) Appl. No.: 13/813,432

(22) PCT Filed: Dec. 5, 2012
(86) PCT No.: PCT/CN2012/085936

§ 371 Date: Jan. 31, 2013

(30) Foreign Application Priority Data
Nov. 13, 2012 (CN) 201220597146.5

(51) Int. Cl. G02F 1/13; G02B 27/12

(52) U.S. Cl. CPC G02F 1/1309; G02B 27/123; G02B 27/126
USPC 359/625; 359/626; 118/621

(57) ABSTRACT

The present disclosure provides a light converging device and a repairing machine having the light converging device. The light converging device includes a transparent plate, and a number of protrusions arranged on the transparent plate each which has a convex surface. The convex surfaces of the protrusions form a light emitting side of the light converging device. With the light converging device with the light emitting side being formed by a number of protrusions, the light can be converged by the light converging device to evenly distribute the energy of the light corresponding to the to-be-repaired position and further improve the yield rate of the repairing operation.

### BACKGROUND

1. Technical Field

The present disclosure relates to technologies of liquid crystal panels, and particularly, to a light converging device for repairing a disconnected defect on an array substrate and a laser repairing machine.

2. Description of Related Art

Liquid Crystal Display (LCD) is a Flat Panel Display (FPD) that uses the characteristics of liquid crystal to display image. Compared to other types of display, LCD is thin and it requires lower driving voltage and lower power consumption, which makes it the mainstream product in the consumer goods market.

Liquid crystal panel is the main component of the LCD. The process for fabricating the liquid crystal panel mainly includes an earlier array fabricating process, a middle cell process, and a later module process. The earlier array fabricating process specifically includes: depositing a film layer on a substrate, coating photoresist on the film layer and carrying out exposing process, developing process, etching process, and photoresist stripping process to form scan lines, a semi-conductor layer, data lines, a protective layer, a transparent conductive layer, etc. After the earlier array fabricating process is finished, the array substrate is detected to determine whether there are disconnected defects and/or short defects in data lines and scan lines. If there are disconnected defects and/or short defects in data lines or scan lines, a repairing machine is used for repairing the disconnected and/or short data lines or scan lines. When there is disconnected defect, the repairing machine at first removes the covering object covering two terminals of the disconnected line, such as the semi-conductor layer, and then coating the two terminals of the disconnected line to form a passageway.

At present, a laser repairing machine removes the covering object by converging laser to the covering object through a convex lens, allowing the covering object on two disconnected terminals of the disconnected line to be removed using laser energy. The present repairing machine uses a single convex lens to converge laser. Although the convex lens can converge laser, the energy of the converged laser corresponding to the middle position of the laser repairing machine is strongest and the energy of the converged laser gradually decreases from corresponding to the middle portion to corresponding to periphery portion thereof, resulting in uneven laser energy of the repairing machine.

### SUMMARY

The present disclosure provides a light converging device which is capable of improving the efficiency of the repairing operation of a repairing machine.

The light converging device provided in the present disclosure includes a transparent plate and a number of protrusions arranged on the transparent plate each which has a convex surface, and the convex surfaces of the protrusions form a light emitting side of the light converging device.

Preferably, each of the protrusions is hemisphere shaped and the convex surface thereof is a spherical surface.

Preferably, each of the protrusions is semi-cylinder shaped and the convex surface thereof is arch shaped.

Preferably, each of the protrusions is annular shaped and the convex surface thereof is a curved surface, and diameters of the protrusions are unequal to each other.

Preferably, each of the protrusions is cone shaped and the convex surface thereof is a cone-shaped surface.

Preferably, each of the protrusions is triangular prism shaped.

Preferably, the protrusions and the transparent plate are integrally formed.

The present disclosure further provides another light converging device. The light converging device includes a light emitting side formed by a number of convex surfaces.

Preferably, the light converging device further includes a number of protrusions each which has the convex surface, and the convex surfaces of the protrusions form the light emitting side.

Preferably, each of the protrusions is hemisphere shaped and the convex surface thereof is a spherical surface.

Preferably, each of the protrusions is semi-cylinder shaped and the convex surface thereof is arch shaped.

Preferably, each of the protrusions is annular shaped and the convex surface thereof is a curved surface, and diameters of the protrusions are unequal to each other.

Preferably, each of the protrusions is cone shaped and the convex surface thereof is a cone-shaped surface.

Preferably, each of the protrusions is triangular prism shaped.

The present disclosure further provides a repairing machine, including: a laser generator; a coating device; and a light converging device having a light emitting side formed by a number of convex surfaces.

Preferably, the light converging device further includes a number of protrusions each which has the convex surface, and the convex surfaces of the protrusions form the light emitting side.

Preferably, each of the protrusions is semi-cylinder shaped, or cone shaped, or triangular prism shaped.

Preferably, each of the protrusions is annular shaped and the convex surface thereof is a curved surface, and diameters of the protrusions are unequal to each other.

Preferably, the light converging device further includes a transparent plate, the protrusions are arranged on one side of the transparent plate, and the other side of the transparent plate without the protrusions arranged thereon forms a light incidence side of the light converging device.

Preferably, the light converging device further includes a transparent plate which is integrally formed with the protrusions.

With the light converging device with the light emitting side being formed by a number of protrusions, the laser can be converged by the light converging device to evenly distribute the energy of the laser corresponding to the to-be-repaired position and further improve the yield rate of the laser repairing operation.

### DESCRIPTION OF THE DRAWINGS

Many aspects of the embodiments can be better understood with reference to the following drawings. The components in the drawings are not necessarily dawns to scale, the emphasis instead being placed upon clearly illustrating the principles of the embodiments. Moreover, in the drawings, like reference numerals designate corresponding parts throughout the several views.

FIG. 1 is a schematic view of a light converging device in accordance with a first embodiment of the present disclosure;

FIG. 2 is a cross-section of the light converging device of FIG. 1;

FIG. 3 is a schematic view of the route of light transmitted from the light converging device of FIG. 1;

FIG. 4 is a schematic view of a light converging device in accordance with a second embodiment of the present disclosure;

FIG. 5 is a schematic view of a light converging device in accordance with a third embodiment of the present disclosure;

FIG. 6 is a schematic view of a light converging device in accordance with a fourth embodiment of the present disclosure; and

FIG. 7 is a schematic view of a light converging device in accordance with a fifth embodiment of the present disclosure.

### DETAILED DESCRIPTION

The disclosure is illustrated by way of example and not by way of limitation in the figures of the accompanying drawings in which like references indicate similar elements. It should be noted that references to “an” or “one” embodiment is this disclosure are not necessarily to the same embodiment, and such references mean at least one.

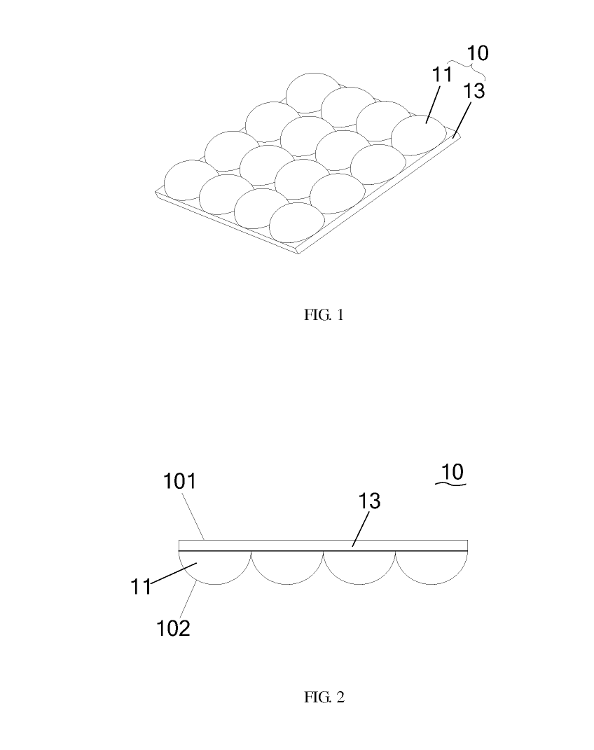

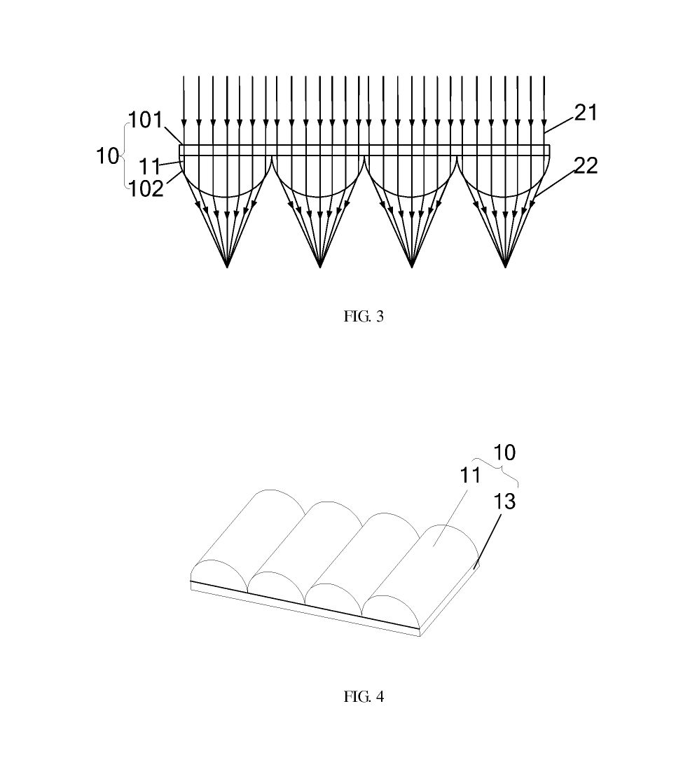

Referring to FIGS. 1 and 2, in which FIG. 1 is a schematic view of a light converging device in accordance with a first embodiment of the present disclosure, and FIG. 2 is a cross-section of the light converging device of FIG. 1. The light converging device 10 includes a light incidence side 101 and a light emitting side 102 having a number of convex surfaces. The light converging device 10 further includes a transparent plate 13 and a number of protrusions 11. Each protrusion 11 is hemisphere shaped and includes a sphere-shaped surface. The protrusions 11 are arranged as a matrix on the transparent plate 13 and are connected to each other. One side of the transparent plate 13 without the protrusions 11 arranged thereon forms the light incidence side of the light converging device 10, and the sphere-shaped surfaces of the protrusions 11 form the light emitting side 102 of the light converging device 10.

In the embodiment, after the protrusions 11 and the transparent plate 13 of the light converging device 10 are independently formed, the protrusions 11 are fixed onto the transparent plate 13. It is note that in other embodiments, the protrusions 11 and the transparent plate 13 may be integrally formed.

In the embodiment, the protrusions 11 are connected to each other, in other embodiments, the protrusions 11 may be arranged on the transparent plate 13 independently.

In the embodiment, the protrusions 11 are regularly arranged on the transparent plate 13 as a matrix. It is noted that in other embodiments, the protrusions 11 can be arranged on the transparent plate 13 as a parallelogram, or as a circle, or as a triangle, or the protrusions 11 can be irregularly arranged on the transparent plate 13.

Referring also to FIG. 3, which is a schematic view of the route of light transmitted from the light converging device. Since the light emitting side 102 of the light converging device 10 is formed by a number of sphere-shaped surfaces, parallel laser light beams enter the light converging device 10 through the light incident side 101 and are refracted when emitting out from the light emitting side 102. Light 22 refracted from each protrusion 11 is converged to a point, thus, the light 22 emitting from the light emitting side 102 is converged to a number of points respectively corresponding to the protrusions 11. That is, the laser forms a number of converging points after passing through the light converging device 10. Additionally, the energy of the light on the area around the converging points of two adjacent protrusions 11 are overlapped, which strengthens the energy of the laser on an area with weak energy. Therefore, with the above light converging device 10, the light 22 converged by the light converging device 10 can be evenly distributed to allow the energy of the converged light 22 to be evenly distributed.

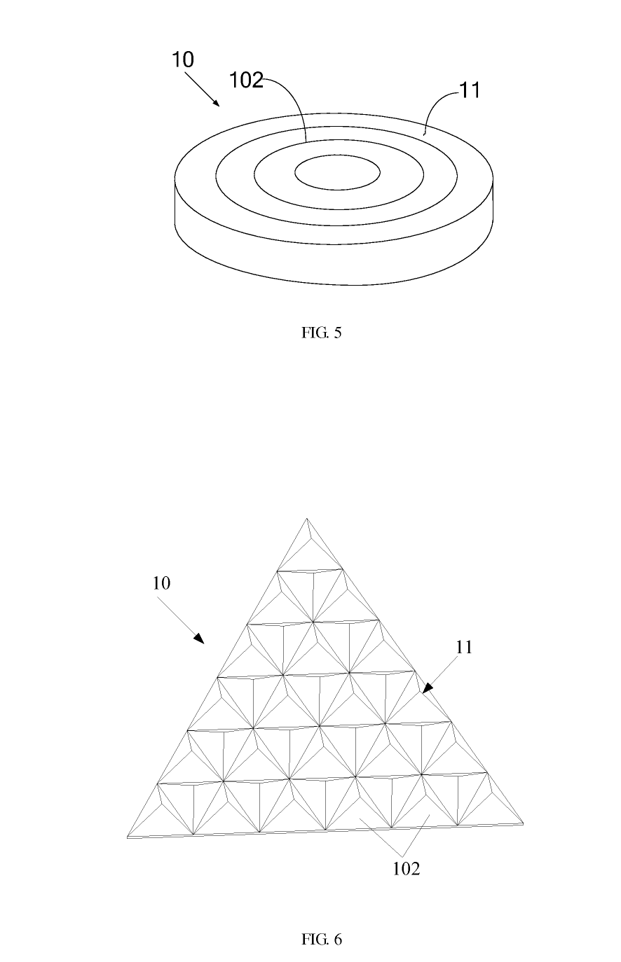

Referring to FIG. 4, which is a schematic view of a light converging device in accordance with a second embodiment of the present disclosure. The difference between the light converging device of the second embodiment and the light converging device of the first embodiment lies that, the protrusions 11 of the light converging device of the second embodiment are respectively semi-cylinder shaped and are arranged on the transparent plate 13 in order. Each semi-cylinder-shaped protrusions 11 has an arch-shaped surface and the arch-shaped surfaces of the protrusions 11 form the light emitting side 102 of the light converging device 10. Compared to the sphere-shaped protrusions 11 of the first embodiment, based on the situation that an area of the transparent plate 13 remains unchanged, the number of the cylinder-shaped protrusions 11 arranged on the transparent plate 13 is reduced, and the connection between two adjacent cylinder-shaped protrusions 11 are more close, which further improves the efficiency of the manufacture of the light converging device 10.

Referring to FIG. 5, which is a schematic view of a light converging device in accordance with a third embodiment of the present disclosure. The difference between the light converging device of the third embodiment and the light converging device of the first embodiment lies that, each protrusion 11 of the light converging device of the third embodiment is annular shaped and has a curved surface. The diameters of the annular-shaped protrusions 11 are unequal to each other. The annular-shaped protrusions 11 are arranged on the transparent plate 13 to allow the light emitting side 102 of the light converging device 10 to be ripple shaped.

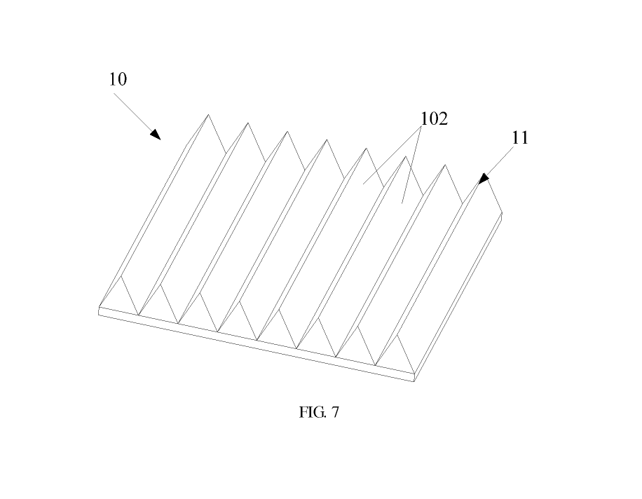

Referring to FIG. 6, which is a schematic view of a light converging device in accordance with a fourth embodiment of the present disclosure, and FIG. 7 is cross-section of the light converging device of FIG. 6. The difference between the light converging device of the fourth embodiment and the light converging device of the first embodiment lies that, each protrusion 11 of the light converging device 10 of the fourth embodiment is triangular pyramid shaped and the light emitting side 102 has a number of cone-shaped surfaces.

In the embodiment, each protrusion 11 is triangular pyramid shaped. It is noted that in other embodiments, the protrusion 11 may be rectangular pyramid shaped, five pyramid shaped, six pyramid shaped, or cone shaped, and the arrangement of the protrusions 11 may be regular or irregular.

Referring to FIG. 7, which is a schematic view of a light converging device in accordance with a fifth embodiment of the present disclosure. The difference between the light converging device of the fifth embodiment and the light converging device of the second embodiment lies that, in the fifth embodiment, each protrusion 11 is triangular prism shaped.

With the light converging device 10 having the light emitting side 102 formed by a number protrusions 11 each which has a convex surface, the laser is converged to a number of converging points after being converged by the light converging device 10, which evenly distributes the energy of the converged laser to improve the yield rate of the laser repairing operation.

The present disclosure further provides a repairing machine, including the light converging device with the structure mentioned above, a laser generator, and a coating device. The laser generator is used for generating parallel laser. The light converging device is arranged between laser generator and a to-be-repaired liquid crystal panel for converging the parallel laser such that the converged light can be used for removing the object covering the to-be-repaired position of the liquid crystal panel. The coating device is used for coating the to-be-repaired position of the liquid crystal panel after the object is removed. The structure of the light converging device can be referred to the light converging device described in embodiments from the first embodiment to the fifth embodiment and shown in FIG. 2 to FIG. 7.

Since the light emitting side of the light converging device is formed by a number of protrusions and thus has a number of convex surfaces, thus, the light refracted by the protrusions are converged to a number of converging points each which has a relatively strengthened light energy. Additionally, the energy of the light on the area around the converging points of two adjacent protrusions are overlapped, which allows the energy of the light converged by the light converging device to be evenly distributed, that is, allows the energy of the laser corresponding to the to-be-repaired position to be evenly distributed, and further improves the efficiency of the repairing operation.

Even though information and the advantages of the present embodiments have been set forth in the foregoing description, together with details of the mechanisms and functions of the present embodiments, the disclosure is illustrative only; and that changes may be made in detail, especially in matters of shape, size, and arrangement of parts within the principles of the present embodiments to the full extend indicated by the broad general meaning of the terms in which the appended claims are expressed.

What is claimed is:

1. A light converging device, comprising:
a transparent plate; and
a number of protrusions arranged on the transparent plate each which has a convex surface, and the convex surfaces of the protrusions forming a light emitting side of the light converging device.

2. The light converging device as claimed in claim 1, wherein each of the protrusions is hemisphere shaped and the convex surface thereof is a spherical surface.

3. The light converging device as claimed in claim 1, wherein each of the protrusions is semi-cylinder shaped and the convex surface thereof is arch shaped.

4. The light converging device as claimed in claim 1, wherein each of the protrusions is annular shaped and the convex surface thereof is a curved surface, and diameters of the protrusions are unequal to each other.

5. The light converging device as claimed in claim 1, wherein each of the protrusions is cone shaped and the convex surface thereof is a cone-shaped surface.

6. The light converging device as claimed in claim 1, wherein each of the protrusions is triangular prism shaped.

7. The light converging device as claimed in claim 1, wherein the protrusions and the transparent plate are integrally formed.

8. A light converging device, wherein the light converging device comprises a light emitting side formed by a number of convex surfaces.

9. The light converging device as claimed in claim 8 further comprising a number of protrusions each which has the convex surface, and the convex surfaces of the protrusions form the light emitting side.

10. The light converging device as claimed in claim 9, wherein each of the protrusions is hemisphere shaped and the convex surface thereof is a spherical surface.

11. The light converging device as claimed in claim 9, wherein each of the protrusions is semi-cylinder shaped and the convex surface thereof is arch shaped.

12. The light converging device as claimed in claim 9, wherein each of the protrusions is annular shaped and the convex surface thereof is a curved surface, and diameters of the protrusions are unequal to each other.

13. The light converging device as claimed in claim 9, wherein each of the protrusions is cone shaped and the convex surface thereof is a cone-shaped surface.

14. The light converging device as claimed in claim 9, wherein each of the protrusions is triangular prism shaped.

15. A repairing machine, comprising:
a laser generator;
a coating device; and
a light converging device having a light emitting side formed by a number of convex surfaces.

16. The repairing machine as claimed in claim 15, wherein the light converging device further comprises a number of protrusions each which has the convex surface, and the convex surfaces of the protrusions form the light emitting side.

17. The repairing machine as claimed in claim 16, wherein each of the protrusions is semi-cylinder shaped, or cone shaped, or triangular prism shaped.

18. The repairing machine as claimed in claim 16, wherein each of the protrusions is annular shaped and the convex surface thereof is a curved surface, and diameters of the protrusions are unequal to each other.

19. The repairing machine as claimed in claim 16, wherein the light converging device further comprises a transparent plate, the protrusions are arranged on one side of the transparent plate, and the other side of transparent plate without the protrusions arranged thereon form a light incidence side of the light converging device.

20. The repairing machine as claimed in claim 16, wherein the light converging device further comprises a transparent plate which is integrally formed with the protrusions.
